(19) United States
(12) Patent Application Publication
(10) Pub. No.: US 2015/0109626 A1
(43) Pub. Date: Apr. 23, 2015

(54) Tire Digitizer

(71) Applicant: Starrett Bytewise Development, Inc., Columbus, GA (US)

(72) Inventor: Michael J. Harris, Columbus, GA (US)

(21) Appl. No.: 14/518,865

(22) Filed: Oct. 20, 2014

Related U.S. Application Data
(60) Provisional application No. 61/893,282, filed on Oct. 20, 2013.

(51) Int. Cl. G01B 11/24; G01D 5/347

(52) U.S. Cl. CPC G01B 11/24; G01D 5/3473
USPC 356/602

(57) ABSTRACT

A tire digitizer system for digitizing the profile of a tire to create a digital model of the tire is described. There is provided a chassis that includes one or more sheet of light triangulation sensors for capturing the profile of a tire moving in a predefined area and outputting coordinate values describing a digital model of the tire. The system may be used during the tire development and manufacturing process to inspect for any defects in the tire.

### RELATED APPLICATIONS

This application claims priority from co-pending Provisional Patent Application No. 61/893,282, filed on Oct. 20, 2013, which is relied upon and incorporated herein by reference.

### FIELD OF INVENTION

This invention relates generally to the art of manufacturing and testing of pneumatic tires. More particularly, the invention relates to a system and method for producing a digital model of a tire for evaluation.

### BACKGROUND OF THE INVENTION

Non-contact profile measurement systems are known in the art, such as Applicant's U.S. Pat. No. 7,679,757, which is incorporated herein by reference.

One of the key challenges for measurements systems used for tire geometry inspection is the reliability and robustness of the geometry digitization system. Tires are digitized during the manufacturing process to inspect for excessive radial runout, lateral runout, sidewall bulges and depressions, and other anomalies. The digitization platforms are typically located on the machines that are inflating the tire for the first or second time after its manufacture. Some tires are subject to catastrophic failure, typically with large sidewall direction forces, which is likely to damage any intricate or sensitive instruments in the area about the tire. Additionally, the mechanical transport mechanisms of tire digitization systems are generally complex, expensive, have high failure rates and high costs of maintenance and repair. The digitization process usually occupies critical cycle time in a force uniformity machine or balance machine for sensor positioning, and also cannot be done during critical stages like chucking, inflating, and load testing due to positioning constraints and risks of damage. The geometric arrangements often involve digitization performed on a not truly radial perspective of the tire, contributing to slight geometrically induced inaccuracies.

Common systems for digitizing tires fail to digitize a complete tire sidewall and tread section from the side perspective, clear of the conveyed and chucked path of the tire. All known digitization systems in use are positioned into close proximity orientations prior to digitizing, and lack digitization capability that is sufficient in speed, accuracy, and range to operate in a position favorable for device protection, generally clear of the conveyed and chucked path of the tire.

Thus, a need exists in the industry to address the aforementioned challenges.

### SUMMARY OF THE INVENTION

A system and method for digitizing the profile of a tire is described herein. Briefly described, in architecture, the system can be implemented as follows. Sensor modules, configured to capture the profile of tire moving within a predefined or predetermined area and output data representative of the tire, are provided. A control unit for receiving, through known electrical transmission (such as a wired infrastructure or known wireless transmission) and processing data received from the sensor module is provided. A chassis to house the sensor modules and control unit is also provided.

In a further embodiment, a system and method for digitizing the profile of a tire is provided that includes a display unit. The display unit is preferably configured to provide a visual representation of a model of the tire.

The system and method described herein provides for 100% digitization of a tire surface from sidewall peak to sidewall peak while on a balancing machine, force uniformity machine, or other tire inflation and rotation machine.

Further, a single tire digitizer can be used to measure tires having various sizes.

Other features and advantages of the tire digitizer and method of use will become apparent to one with skill in the art upon examination of the following drawings and detailed description. It is intended that all such additional features and advantages be included herein within the scope of the present invention.

### BRIEF DESCRIPTION OF THE FIGURES

FIG. 1 is a block diagram illustrating a representation of an embodiment of a tire digitizer system.

FIG. 2 is a side view illustrating an embodiment of the present invention which includes a sealed chassis and sensing modules with projected light beams impinging on the sidewall and tread face of a tire.

FIG. 3 is an illustrative top view of one of a plurality of triangulation modules according to the present invention.

FIG. 4 is a dimensioned side view illustration of an embodiment of a tire digitizer according to the present invention.

### DETAILED DESCRIPTION OF THE INVENTION

Embodiments of the invention will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

In the following description, numerous specific details are set forth. However, it is to be understood that embodiments of the invention may be practiced without these specific details. In other instances, well-known methods, structures and techniques have been shown in detail in order not to obscure an understanding of this description.

In a preferred embodiment, the system and method is configured to digitize the profile of a tire for evaluation. In a further embodiment, the system and method includes a display unit configured to provide for a visual representation of a tire for inspection and evaluation. The displayed representation is based upon captured profile data. The display unit may display information in accordance with instructions received from the control unit.

Tire Digitizer

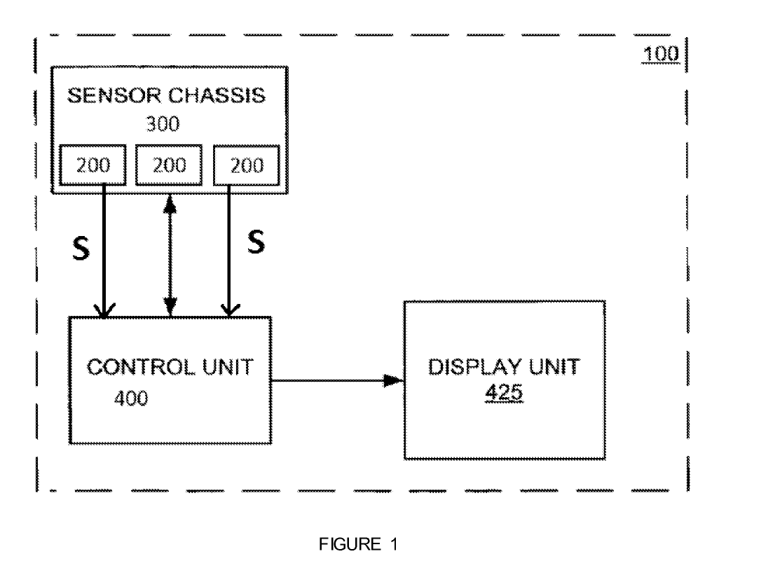

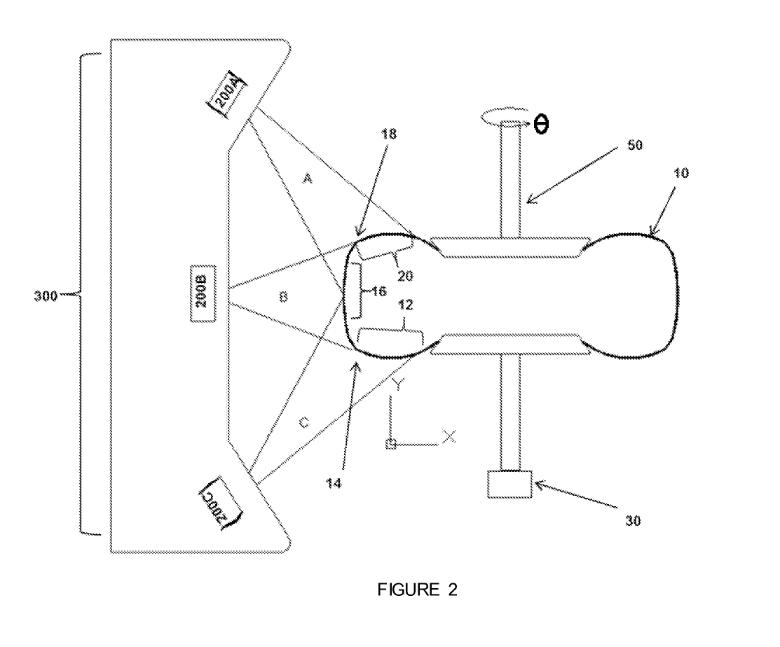

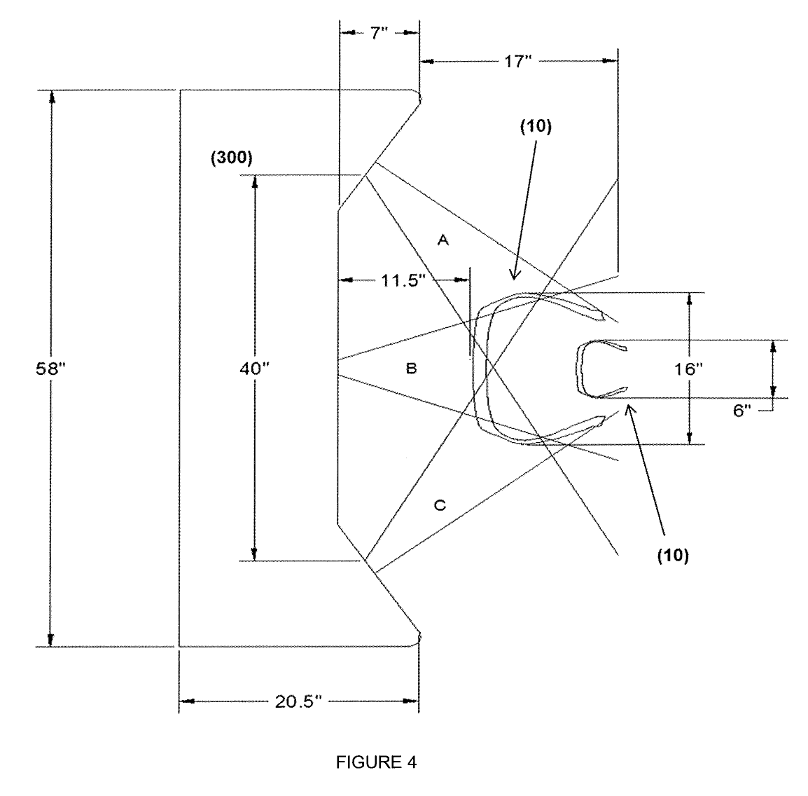

FIG. 1 is a block diagram illustrating a representation of an embodiment of a tire digitizer system 100 according to the present invention. A sensor holding chassis (chassis) 300 is provided, along with a control unit 400 (i.e., a computer processor) and a display unit 425. Multiple sheet of light triangulation sensing modules (sensing modules) 200 are mounted to the chassis 300 (or other framework). The sensing modules 200 are in electrical communication with the control unit 400, where the communication medium may be wired or wireless. The display unit 425 is in electrical communication with the control unit 400, where the communication medium may be wired or wireless. The chassis 300 is configured to capture the profile of a tire 10 within a predefined area (not shown) by generating and outputting data representing at least a portion of the profile of the tire that is located within the predefined area. The predefined area is a space in which the tire 10 (see FIG. 2, FIG. 4) may be rotated for evaluation. Display unit 425 is preferably included for displaying information in accordance with instructions received from the control unit 400.

FIG. 2 is a side view illustrating an embodiment of the present invention which includes a sealed chassis 300 and sensing modules 200A, 200B, 200C with projected light beams (A, B, C) impinging on the sidewall and tread face of a tire 10. The chassis 300 is configured to allow one or more sensing modules 200 (200A, 200B, 200C) to be focused on the tire 10. However, while three modules are shown in FIG. 2, more modules 200 may be included as desired. Module 200B is positioned to have a field of view B of the tire tread or tread face 16. Sensing module 200A is positioned at an offset angle from sensing module 200B, such that it has a field of view A of the left side wall of tire 10 and a portion of the tire tread 16. Sensing module 200C is positioned at an offset angle from sensing module 200B, such that it has a field of view C of the left side wall of tire 10 and a portion of the tire tread 16. The sensing modules 200A, 200B, 200C are preferably positioned so a profile of the tire 10, approximately 270 degrees around the tire 10, may be collectively captured by the sensors associated with the sensing modules 200A, 200B, 200C.

An inflated tire 10 is attached to axle 50 and rotated for evaluation. The angle of rotation of the tire 10 may be measured using a rotary encoder 30 in communication with the axle 50.

Triangulation Sensing Module

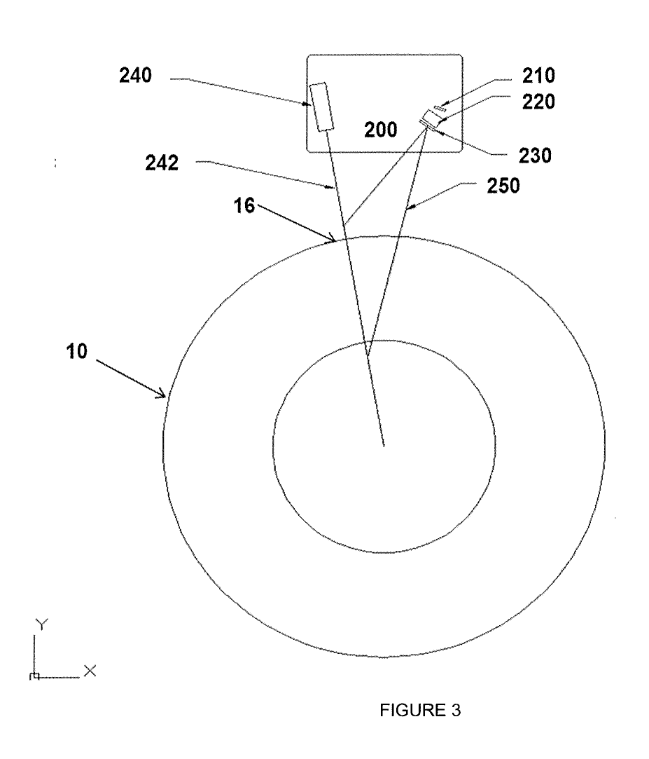

FIG. 3 is an illustrative top view of one of a plurality of triangulation modules according to the present invention. Optimizations to the present invention can be made by constructing each sheet of light triangulation sensing modules from components to achieve the precise field of view, speed, resolution, and laser power needed. Each sensing module 200 includes a camera or imager 210, lens 220, filter 230, and light beam generator 240 that is able to produce a light beam 242 with a unique wavelength associated with the light beam generator 240. The light beam 242 is aligned on the radial axis of the tire 10.

A preferred embodiment of the tire digitizer 100 will include two or more sheet of light triangulation sensing modules 200 mounted in the sealed chassis 300 proximate optical windows positioned in the chassis 300. FIG. 3 illustrates a sensing module 200 oriented to have the tread face 16 of the tire within its field of view (FOV) 250. Each of the sensing modules 200A, 200B, 200C is uniquely aligned with the tire 10. As previously noted, the sensing modules 200A, 200B, 200C are oriented in a way such that each sensing module 200A, 200B, 200C can see part of a tire sidewall 12, 20 and/or tread face 16 (FIG. 2).

Referring to FIG. 2 and FIG. 3, when the tire 10 is positioned near the chassis 300, it will preferably be within the FOV of each of the sensing modules 200A, 200B, 200C. Each sensing module 200 will emit its respective light beam or light beam 242; it strikes the tire 10 and is reflected, at least in part, back to the imager 210. In response, the camera/imager 210 will generate an output signal S representative of the sensor coordinates describing the profile of the tire 10 within the sensor coordinate plane. This output signal S is then output to the control unit 400. Each sensing module 200A, 200B, 200C is preferably attached to the sensor chassis 300 via an interface (not shown) that allows the sensing module 200A, 200B, 200C to be aligned so that the light beam 242 emitted by the sensing module 200A, 200B, 200C corresponds to a predetermined plane.

FIG. 4 is a dimensioned side view illustration of an embodiment of a tire digitizer according to the present invention. The present invention allows for the position of the chassis 300 to remain stationary and still measure tires having a width from approximately six inches to sixteen inches (or greater). The distance from the tire 10 to the chassis 300 of the illustrated embodiment is generally from 11.5 inches to 17 inches, to allow for the tire 10 to move along a path of travel proximate the chassis 300 so that measurements can be made, but distant from the chassis 300 to not require any movement of the chassis 300.

In a preferred embodiment, each of the sensing module 200A, 200B, 200C are aligned so that the light beams 242 emitted by each contour sensor is substantially aligned along a common plane (plane of inspection).

Profiles of the tire 10 are taken in precise succession, at known rotational intervals, as the tire 10 is rotated on axle 50. When feedback data from light beams 242 associated with each sensing module (200A, 200B, 200C) are combined, a profile data set associated with the tire 10 is produced. The profile data set comprises a complete section view of the tire 10, including the dimensions of the front left sidewall 12, the tread face 16, and the front right sidewall 20.

A common coordinate system, including a digitized Cartesian coordinate data cloud model of the tire 10, is produced from the single data set. A precise digital XYZ data cloud model of the tire 10 is then produced from the acquired profile data. The data acquired can feed into existing analysis software, as well as enable new forms of analysis based on the new data available, in particular a complete digital model extending from sidewall peak to sidewall peak.

Triangulation Sensing Module Data Registration

The profile data produced by each triangulation sensing module 200 must be transformed from its sensor 200 coordinate space into a common tire coordinate space, such as a digitized Cartesian coordinate data cloud model of the tire 10, from the single data set. The preferred method is described in U.S. Pat. No. 7,679,757. Described briefly, each sensing module 200 will “see” a tire 10 whose coordinates in the chassis 300 coordinate space are known, and the translation (X, Y) and Rotation (0) needed to shift the data from sensor coordinate space into chassis coordinate space can be determined. The rotation θ is measured using a rotary encoder 30 engaged with the axle 50. The X, Y, and θ coordinates are then used to transform or correlate every point acquired from the sensor coordinate space into the chassis coordinate space. The registration of the data from the sensor 200 to the chassis 300 coordinate space can be performed one time at the time of manufacture, or it can be performed as needed—such as when the chassis undergoes slight changes such as those induced by thermal expansion. The chassis coordinate space has one axis aligned to the laser plane, so that it is essentially the same coordinate system as the tire when the offset distance is known from tire origin (center point) to chassis origin (arbitrary, but on the laser plane axis). The triangulation sensing module 200 will process the image of the tire 10 to produce a profile data set comprising sub-pixel resolution values associated with the image of the tire 10.

The operational procedure of the tire digitizer 100 is as follows:

With laser lines 242 projecting on the target tire 10, an image is captured by the imager 210 associated with each sensing module 200A, 200B, 200C.

The current position of the rotary encoder 30 is captured simultaneous to the image capture by the imager 210.

The image is triangulated, resulting in a sub-pixel range value for every column of the imager 210 that contains an image of the laser line 242. In the preferred embodiment, this will happen in the memory of the camera 210, but it could also happen in the computer memory of the control unit 400.

The profile data is transmitted to a processing system, such as a personal computer 400.

The profile data (pixel position values) are transformed into world coordinates (microns) by a calibration routine. In the preferred embodiment, this will happen in the computer, but it could also happen in the camera.

The data set from each imager 210 is transformed into the chassis coordinate system.

The transformed data sets are transferred to a processor 400, such as a host analysis or data storage system.

Test to see if the host system is continuing to request data. If yes, go to the first step and cycle through the steps once again. If No, repeat the test to see if the host system is continuing to request data.

Best Mode Description

The best mode contemplated by the inventors for the use of the invention is now described in detail. When assembling components for optimal design, the following considerations are noted:

Camera/Imager

The camera/imager 210 must support effective imaging of the projected light beam 242 at sufficiently high-resolution and speed to enable the required performance. Further, it is preferable that the camera/imager 210 have triangulation capabilities built directly into the hardware. However, it is not necessary, to perform the triangulation calculations directly in hardware, and a high speed, high-resolution camera/imager is suitable if the triangulation is to be performed in an external processor such as a personal computer (PC).

Lens and Lens Mount

The lens 220 is preferably mounted in an orientation, relative to the projected light beam 242, known as the “Scheimpflug Condition” in which the focal plane aligns or falls perfectly onto the plane of the projected light beam 242, eliminating issues associated with limited depth of field.

It may be advantageous to utilize more specialized lenses with features such as anamorphic field of view, in order to create the optimum field of view for the imager. In such a case, a stand-along Scheimphlug mount can be used. However, such utilizations are optional. Further, the lens used should offer sufficiently high resolution and a sufficiently large image circle for this application, and come in a variety of focal lengths.

Light Beam Generator and Interference Filter

The light beam generator 240 should provide a light stripe less than 0.25 mm in width throughout the 12″ depth of field. The light beam 242 should have sufficient power, typically 1 milliwatt per 10 mm of length, to enable imaging at very short exposure intervals of less than 1 msec. A different wavelength of light beam generator 240 should be used with each sensing module 200 of the plurality of sensing modules 200 (and associated interference filter 230) so that the light beam 242 can only be seen by its respective imager 210 and will not cause interference with the light beams 242 of the other light beam generators 240.

The interference filter should allow each imager to see only its associated light beam generator.

It should be noted that multiple line laser generators 240 can be used per triangulation sensing module 200, optimizing the position of their focus, and selectively turned on or off depending on size of tire 10 to be digitized.

Operating the Tire Digitizer

The system and method for digitizing the profile of a tire is optimized whenever operating the tire digitizer 100 at 1000 profiles per second or faster. The accuracy of the tire digitizer 100 is +/−50 micron or better, and the repeatability of the digitizer is 25 microns or better for one standard deviation. The depth of range of the system allows coverage for the full range of passenger and light truck tires, from 12″ to 32″ in diameter, and from 4″ to 16″ in section width.

Furthermore, the light projecting and camera visualizing—angles are preferably such that the entire system can operate from a large side distance, eliminating the need to reposition the measurement sensor, and associated cycle time and maintenance costs, as well as decreasing the risk of damage to the tire digitizer 100 by mischucked tires, or tires that burst during initial inflation.

Advantages of the Present Tire Digitizer

Some of the advantages of the tire digitizer 100 are the elimination of the cost and complexity of the mechanical positioning systems; elimination of the cycle time associated with mechanical positioning; elimination of inaccuracies induced by non-radial views of the tire 10; the ability to operate from a lower risk, long range distance, clear of the travel path of the tire 10; and the ability to accurately capture the absolute geometry of the tire at high speed and during any desired phase of testing such as chucking, inflation and loading.

Unlike other systems for digitizing tires 10, the tire digitizer 100 described in this application will digitize a complete tire sidewall and tread section 12, 16, 20 from the side perspective, clear of the conveyed and chucked path of the tire 10. There are no other known attempts to digitize a complete tire sidewall and tread section 12, 16, 20 from the side perspective, clear of the conveyed and chucked path of the tire 10. On the contrary, all known digitization systems in use are positioned into close proximity orientations prior to digitizing. In contrast, this digitizer described in this application is a system with digitization capability that is sufficient in speed, accuracy, and range to operate in a position favorable for device protection, clear of the conveyed and chucked path of the tire.

The digitizer 100 provides a system for 100% digitization of the tire surface from sidewall peak 12 to sidewall peak 20 while on balancing machine or force uniformity machine has not been devised prior to this invention.

In addition, a single digitizer 100 can be used to measure tires 10 having various sizes. For example, it is foreseen that the position of the chassis 300 can remain stationary and still measure tires having a width from six inches to sixteen inches (or greater). The distance from the tire 10 to the chassis 300 of the illustrated embodiment is from 11.5 inches to 17 inches, to allow for the tire 10 to move along a path of travel proximate the chassis 300 so that measurements can be made, but distant from the chassis 300 to not require any movement of the chassis 300, unlike prior attempts at digitizing items.

Having thus described exemplary embodiments, it should be noted by those skilled in the art that the within disclosures are exemplary only and that various other alternatives, adaptations, and modifications may be made within the scope of this disclosure as described herein and as described in the appended claims.

What is claimed is:

1. A system for digitizing a profile of a tire as it moves within a predefined area comprising:
a chassis positioned in proximity to the tire within the predefined area;
a plurality of sensing modules mounted on the chassis, where the sensing modules capture a substantially 270 degrees profile of the tire within the predefined area and generate a profile data representative of the profile of a tire; and
a control unit in electrical communication with the sensing modules to process data from the sensing modules and correlate a coordinate space associated with the sensing modules with a common coordinate space.

2. The system of claim 1, wherein each sensing module comprises:
a sheet of light triangulation sensors further comprising:
an imager operative for triangulation and high resolution;
at least one of a plurality of light beam generators, wherein the at least one light beam generator projects a light beam with a unique wavelength associated with the at least one light beam generator;
a lens oriented relative to the light beam, wherein the focal plane of the lens aligns with the plane of the light beam, and;
an interference filter associated with allow the sensing module imager to see only the associated light beam generator.

3. The system of claim 1, wherein the sensing modules are registered to a common coordinate system to produce a single data set.

4. The system of claim 3, wherein a digitized Cartesian coordinate data cloud model of the tire is produced from the single data set.

5. The system of claim 4, wherein at least one sensing module is positioned proximate the front left sidewall of the tire, one sensing module is positioned proximate the front right sidewall of the tire, and one sensing module is positioned proximate the tread face dimensions of the tire.

6. The system of claim 5, wherein the single data set comprises an angle of rotation of the tire and the profile data including:
front left sidewall dimensions of the tire;
front right sidewall dimensions of the tire, and;
tread face dimensions of the tire.

7. A method for digitizing a profile of a tire as the tire moves within a predefined area, the tire having a tread face, a front left sidewall, and a front right sidewall, the method comprising:
positioning a tire chassis in proximity to the tire within the predefined area;
capturing a substantially profile of the tire substantially 270 degrees around the tire within the predefined area;
generating a profile data representative of the profile of a tire comprising front left sidewall dimensions of the tire, front right sidewall dimensions of the tire, and tread face dimensions of the tire;
electrically transmitting process data from each sensing module to a control unit; and
correlating a coordinate space associated with the sensing modules with a common coordinate space by the control unit.

8. The method of claim 7, further comprising the steps of:
providing a sheet of light triangulation sensors in the sensing modules comprise, the sensors comprising:
an imager operative for triangulation and high resolution;
at least one of a plurality of light beam generators, wherein the at least one light beam generator projects a light beam with a unique wavelength associated with the at least one light beam generator;
a lens oriented relative to the light beam, wherein the focal plane of the lens aligns with the plane of the light beam, and;
an interference filter.

9. The method of claim 8, further comprising the step of:
registering the sensing modules into a common coordinate system to produce a single data set, the single data set comprising an angle of rotation of the tire and the profile data.

10. The method of claim 9, further comprising the step of producing a digitized Cartesian coordinate data cloud model of the tire from the single data set.

11. An operational procedure for a tire digitizer including:
projecting light beams from an at least one of a plurality of light beam generators;
using at least one of a plurality of imagers to capture a profile image of the tire;
simultaneously capturing the angle position of a rotary encoder used when rotating the tire;
triangulating the image of the tire to produce a profile data set;
transmitting the profile data set to a processor;
processing the profile data set, such that the resolution values are calibrated according to a reference data set, wherein the profile data set is transformed into coordinates;
transforming the profile data set from the plurality of imagers to a data storage system, and
cycling through the operational procedure if the processor requests profile data.
